(19) United States
(12) Patent Application Publication
(10) Pub. No.: US 2022/0238126 A1
(43) Pub. Date: Jul. 28, 2022

(54) METHODS OF ENCODING AND DECODING AUDIO SIGNAL USING NEURAL NETWORK MODEL, AND ENCODER AND DECODER FOR PERFORMING THE METHODS

(71) Applicant: ELECTRONICS AND TELECOMMUNICATIONS RESEARCH INSTITUTE, Daejeon (KR)

(72) Inventors: Jongmo SUNG, Daejeon (KR); Seung Kwon BEACK, Daejeon (KR); Tae Jin LEE, Daejeon (KR); Woo-taek LIM, Sejong-si (KR); Inseon JANG, Daejeon (KR)

(21) Appl. No.: 17/570,489

(22) Filed: Jan. 7, 2022

(30) Foreign Application Priority Data
Jan. 28, 2021 (KR) 10-2021-0012224
Nov. 8, 2021 (KR) 10-2021-0152153

(51) Int. Cl. G10L 19/032; G10L 19/008; G10L 25/90; G10L 25/30

(52) U.S. Cl. CPC G10L 19/032; G10L 25/30; G10L 25/90; G10L 19/008

(57) ABSTRACT

Methods of encoding and decoding an audio signal using a learning model and an encoder and a decoder for performing the methods are disclosed. A method of encoding an audio signal using a learning model may include extracting pitch information of the audio signal, determining a dilation factor of a receptive field of a first expandable neural network block to extract a feature map from the audio signal based on the pitch information, generating a first feature map of the audio signal using the first expandable neural network block in which the dilation factor is determined, determining a second feature map by inputting the first feature map into a second expandable neural network block to process the first feature map, and converting the second feature map and the pitch information into a bitstream.

### CROSS-REFERENCE TO RELATED APPLICATIONS

This application claims the benefit of Korean Patent Application No. 10-2021-0012224 filed on Jan. 28, 2021, and Korean Patent Application No. 10-2021-0152153 filed on Nov. 8, 2021, in the Korean Intellectual Property Office, the entire disclosures of which are incorporated herein by reference for all purposes.

### BACKGROUND

### 1. Field of the Invention

The following description relates to methods of encoding and decoding an audio signal using a neural network model and an encoder and a decoder for performing the methods, and more particularly, to a technique of encoding and decoding to remove redundancy inherent in an audio signal using a neural network model utilizing pitch information of the audio signal.

### 2. Description of Related Art

Recently, as artificial intelligence (AI) technology has been developing, the technology has been applied in various fields such as fields related to processing voice, an audio signal, a language and an image signal, and related studies are being actively conducted. As a representative example, a technology for extracting a feature of an audio signal using a deep learning-based autoencoder and restoring the audio signal based on the extracted feature is used.

However, in restoring an audio signal, using a conventional AI model may increase a complexity of an operation and may be inefficient for removing short-term redundancy and long-term redundancy inherent in the audio signal. Thus, there is a demand for a solution to such problems.

### SUMMARY

Example embodiments provide a method of effectively removing long-term redundancy inherent in an audio signal in a process of encoding and decoding the audio signal by variably determining a dilation factor of a neural network model using pitch information of the audio signal.

In addition, example embodiments provide a method and apparatus for improving a quality of restored audio signal and reducing a complexity of an operation by determining a dilation factor of a neural network model using pitch information of the audio signal.

According to an aspect, there is provided a method of encoding an audio signal using a neural network model, the method including extracting pitch information of the audio signal, determining a dilation factor of a receptive field of a first expandable neural network block to extract a feature map from the audio signal based on the pitch information, generating a first feature map of the audio signal using the first expandable neural network block in which the dilation factor is determined, determining a second feature map by inputting the first feature map into a second expandable neural network block to process the first feature map, and converting the second feature map and the pitch information into a bitstream.

The first feature map may include generating the first feature map by changing a number of channel for the audio signal and inputting the changed number of channel of the audio signal to the first expandable neural network block, and the determining of the second feature map may further include changing a number of channels of the determined second feature map.

The determining of the second feature map may include performing downsampling on the first feature map to reduce a dimension of the first feature map and determining the second feature map by inputting the downsampled first feature map into the second expandable neural network block.

The determining of the dilation factor may include determining the dilation factor by approximating the receptive field of the first expandable neural network block with the pitch information.

A dilation factor of the second expandable neural network block may be predetermined to be a fixed value, and a receptive field of the second expandable neural network block may be determined based on the dilation factor of the second expandable neural network block.

The method may further include quantizing the second feature map and the pitch information respectively, wherein the converting into the bitstream may include converting the quantized second feature map and the quantized pitch information into the bitstream by multiplexing.

According to an aspect, there is provided a method of decoding an audio signal using a neural network model, the method including extracting a second feature map of the audio signal and pitch information of the audio signal from a bitstream received from an encoder, restoring a first feature map by inputting the second feature map into a second expandable neural network block to restore a feature map, determining a dilation factor of a receptive field of a first expandable neural network block to restore an audio signal from a feature map based on the pitch information, and restoring an audio signal from the first feature map using the first expandable neural network block in which the dilation factor is determined.

The restoring of the first feature map may further include restoring the first feature map by changing a number of channels of the second feature map and inputting the changed number of channel into the second expandable neural network block, and the restoring of the audio signal further may include changing a number of channels of the restored audio signal to be same as a number of channels of an input signal of the encoder.

The restoring of the audio signal may include performing upsampling on the first feature map to expand a dimension of the first feature map and determining the audio signal by inputting the upsampled first feature map into the first expandable neural network block.

The dilation factor may be determined by approximating the receptive field of the first expandable neural network block with the pitch information in the encoder.

A dilation factor of the second expandable neural network block may be predetermined to be a fixed value, and a receptive field of the second expandable neural network block may be determined based on the dilation factor of the second expandable neural network block.

The extracting of the second feature map and the pitch information of the audio signal further may include inversely quantizing the second feature map and the pitch information respectively.

According to an aspect, there is provided an encoder for performing a method of encoding an audio signal, the encoder including a processor, wherein the processor may be configured to extract pitch information of the audio signal, determine a dilation factor of a receptive field of a first expandable neural network block to extract a feature map from the audio signal based on the pitch information, generate a first feature map of the audio signal using the first expandable neural network block in which the dilation factor is determined, determine a second feature map by inputting the first feature map into a second expandable neural network block to process the first feature map, and convert the second feature map and the pitch information into a bitstream.

The processor may be further configured to perform downsampling on the first feature map to reduce a dimension of the first feature map and determine the second feature map by inputting the downsampled first feature map into the second expandable neural network block.

The processor may be further configured to determine the dilation factor by approximating the receptive field of the first expandable neural network block with the pitch information.

A dilation factor of the second expandable neural network block may be predetermined to be a fixed value and a receptive field of the second expandable neural network block may be determined based on the dilation factor of the second expandable neural network block.

Additional aspects of example embodiments will be set forth in part in the description which follows and, in part, will be apparent from the description, or may be learned by practice of the disclosure.

According to example embodiments, long-term redundancy inherent in an audio signal in a process of encoding and decoding the audio signal based on a neural network may be effectively removed by variably determining a dilation factor of an expandable neural network model using pitch information of the audio signal.

In addition, according to example embodiments, by variably determining a dilation factor of an expandable neural network model using pitch information of an audio signal, a quality of an audio signal restored through a variable neural network encoding and decoding model may be improved and a complexity of an operation may be reduced compared to a conventional expandable neural network model having a fixed dilation factor.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an encoder and a decoder according to an example embodiment;

FIG. 2 is a diagram illustrating a process of processing an encoding method and a decoding method according to an example embodiment;

FIGS. 3A and 3B are diagrams illustrating a layer structure of a neural network model according to an example embodiment; and

FIG. 4 is a diagram illustrating a layer structure of a neural network model that is determined based on pitch information according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

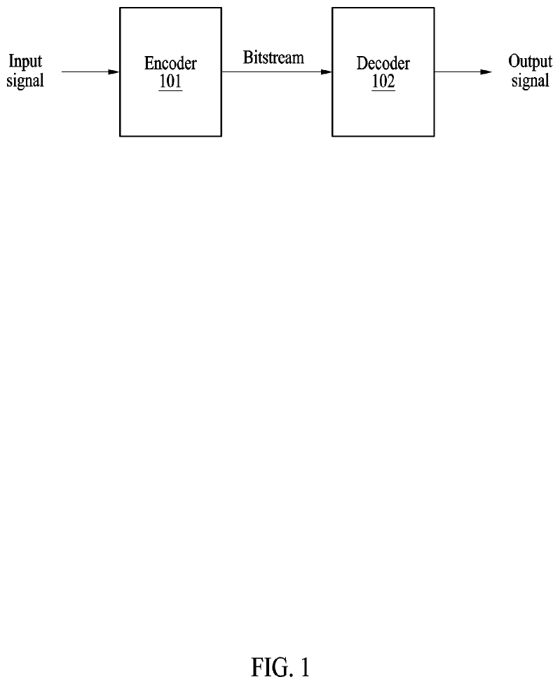

FIG. 1 illustrates an encoder and a decoder according to an example embodiment.

In encoding and decoding an audio signal, the present disclosure relates to a technique to reduce short-term redundancy and long-term redundancy generated in the process of encoding and decoding an audio signal by determining a receptive field of an artificial intelligence (AI)-based neural network model using pitch information of the audio signal and encoding and decoding the audio signal through the neural network model.

An encoder and a decoder performing the encoding method and the decoding method respectively may include a processor such as a smartphone, a desktop computer, and a laptop computer. The encoder and the decoder may be different electronic devices or a same electronic device.

An encoding and decoding model may be a neural network model based on deep learning. For example, the encoding and decoding model may be an autoencoder configured in a convolutional neural network. The encoding and decoding model is not limited to examples described in the present disclosure and various types of neural network models may be used.

The neural network model may include an input layer, a hidden layer, and an output layer, and each of the layers may include a plurality of nodes. A node of each of the layers may be calculated by a product of nodes of a previous layer and a matrix configured to have a predetermined weight. A weight of the matrix between the layers may be updated in a process of training the neural network model. More particularly, in case of a convolutional neural network, a filter which is a weight matrix may be used to calculate a feature map for a layer. In general, a feature map of each layer may be calculated through a plurality of filters and a number of used filters may be a number of channels.

The neural network model may generate output data for input data. The input layer may correspond to the input data of the neural network model and the output layer may correspond to the output data of the neural network model. The input data and the output data may be a vector representing an audio signal that has a predetermined length (frame). In case the input data and the output data are configured in a plurality of audio frames, the input data and the output data may be represented by a two-dimensional matrix.

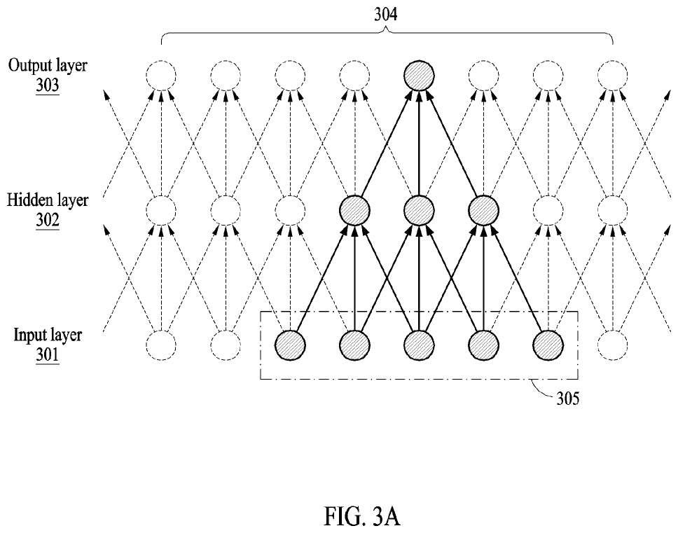

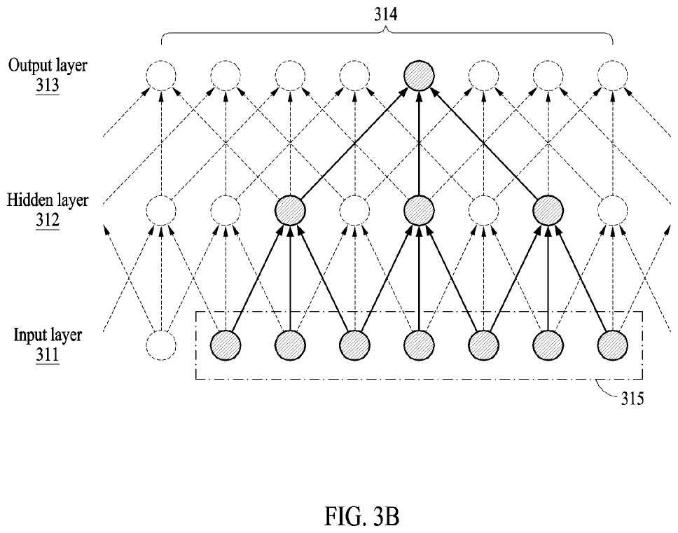

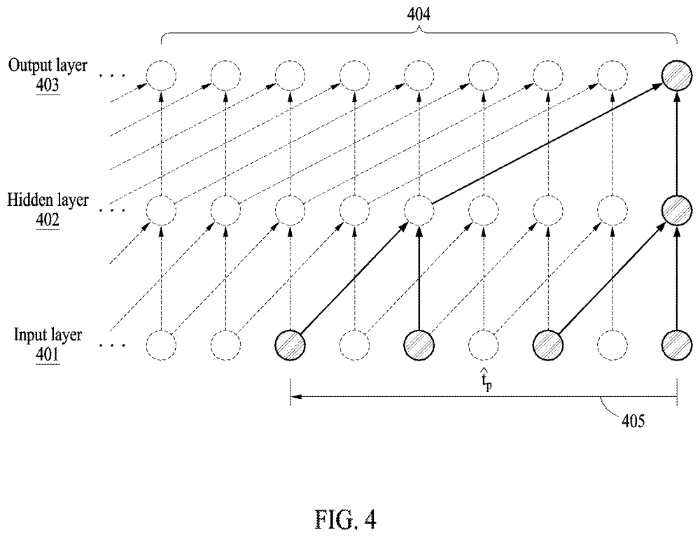

The feature map for each layer of the neural network model may be a one-dimensional vector, a two-dimensional matrix, or a multi-dimensional tensor representing a feature of an audio signal. For example, the feature map may be data obtained by an operation between the input data or a feature map of a previous layer and a weight filter of the layer. A receptive field of the neural network model may be a number of input nodes used to calculate a value of each node of an output layer and may be determined based on a length of the weight filter and a number of layers in a configuration of a learning model. The receptive field of an expandable neural network model may be additionally determined by a dilation factor. A receptive field of a neural network model based on a dilation factor is described in FIGS. 3A, 3B, and 4.

A number of channels of an input signal may vary based on a signal representation possessed by an original signal. For example, for a mono signal and a stereo signal of an audio signal, a number of channels may be one and two respectively and in case of a signal of a red, green, and blue (RGB) colored image, a number of channels may be three. Meanwhile, in a convolutional neural network, a number of channels of an output feature map may be determined based on a number of convolutional filters used to calculate the output feature map.

Pitch information of an audio signal may be information indicating a periodicity of the audio signal. For example, the pitch information may represent a periodicity inherent in an input audio signal. The pitch information may be utilized in modeling long-term redundancy of a signal in a typical audio compressor and may refer to a pitch lag for each frame. That is, the pitch information may be defined as a difference between a previous point in time and a predetermined point in time, wherein the previous point in time is retrieved by a method of retrieving a point in time that has a greatest correlation between an audio signal of the predetermined point in time and an audio signal of the previous point in time. In this case, a retrieval point in time may include a point in time within a frame of the corresponding audio signal and a point in time of previous frames.

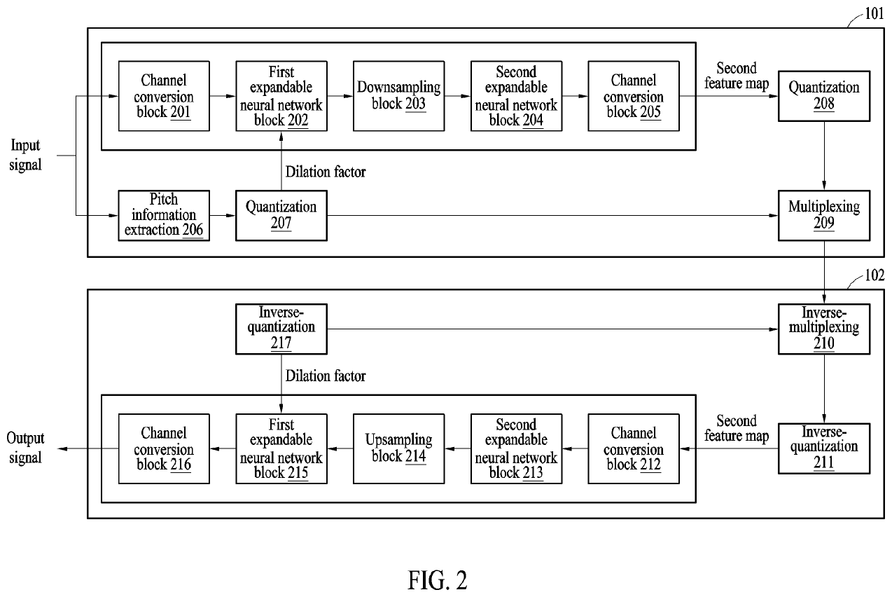

Referring to FIG. 1, an encoder may generate a bitstream by encoding an input signal and a decoder may generate an output signal from the bitstream received from the encoder. The input signal may refer to an original audio signal that the encoder receives and the output signal may refer to an audio signal restored in the decoder. A detailed operation of encoding and decoding an audio signal using a learning model is described in FIG. 2.

FIG. 2 is a diagram illustrating a process of processing an encoding method and a decoding method according to an example embodiment.

A neural network model including a channel conversion block 201, a first expandable neural network block 202, a downsampling block 203, a second expandable neural network block 204, a channel conversion block 205 may be used in encoding an input signal.

In pitch information extraction 206, an encoder 101 may extract pitch information of an audio signal. For example, the encoder 101 may extract pitch information by calculating a normalized autocorrelation for an audio signal frame with respect to each point in time within a predetermined pitch lag retrieval range and then, retrieving a point in time that has a greatest value. A detailed method of extracting pitch information is not limited to the described examples.

In quantization 207, the encoder 101 may quantize the extracted pitch information to a value that may be represented by a predetermined bit number. In addition, the encoder 101 may convert the quantized pitch information into a bitstream.

The encoder 101 may determine a dilation factor of the first expandable neural network block 202 based on the quantized pitch information. A receptive field of the first expandable neural network block 202 may be determined based on a filter length, a number of layers and the dilation factor. The filter length and the number of layers may be predetermined in a process of designing the neural network model, however, the dilation factor may be calculated based on the quantized pitch information by each audio frame.

The first expandable neural network block 202 may be a convolutional neural network to calculate a new output feature map from an input feature map and may be a neural network block having a dilation factor that is variably determined based on the pitch information. The first expandable neural network block 202 may be distinguished from the second expandable neural network block 204 of which a dilation factor is fixed.

Unlike in a conventional expandable neural network that has a fixed dilation factor, a complexity of an operation may be reduced since a sufficient receptive field required for long-term modeling with a relatively small number of layers may be obtained by not excessively extending a filter length and a number of layers of a neural network block for a wide receptive field, and variably determining the dilation factor of the first expandable neural network block 202 based on the pitch information.

For example, the channel conversion blocks 201 and 205, the downsampling neural network block 203, the first expandable neural network block 202 and the second expandable neural network block 204 used in the encoder 101 may be components of the encoder 101 of an autoencoder using a convolutional neural network and the channel conversion blocks 201 and 216, an upsampling neural network block 214, the first expandable neural network block 215 and the second expandable neural network block 213 used in the decoder 102 may be components of the decoder 101 of the autoencoder using the convolutional neural network.

For example, in the encoder 101, the channel conversion block 201 may be a neural network block to output a channel-converted feature map by extracting various features included in an input signal by applying convolution having a plurality of filters (corresponding to a number of channels of an output feature map) to an input audio signal that is single or two-channel.

The first expandable neural network block 202 used in the encoder 101 may be a neural network block to output a first feature map from which long-term redundancy inherent in an audio signal is removed by applying expandable convolution that has a dilation factor based on the quantized pitch information to the channel-converted feature map output from the channel conversion block 201. The first feature map may be a feature map output from the first expandable neural network block used in the encoder 101, may be used as input data of the second expandable neural network block and may be distinguished from a second feature map that is output data of the second expandable neural network block. The second feature map may be a processed feature map of the first feature map processed by the second expandable neural network block.

The downsampling block 203 used in the encoder 101 may be a neural network block to output a downsampled feature map in which a dimension of the input feature map is reduced by applying strided convolution or convolution combined with pooling to the first feature map output from the first expandable neural network block 202.

The second expandable neural network block 204 used in the encoder 101 may be a neural network block to output a second feature map from which short-term redundancy inherent in an audio signal is removed by applying expandable convolution that has a fixed dilation factor to the feature map output from the downsampling neural network block. The encoder 101 may determine the second feature map based on the first feature map that is downsampled using the second expandable neural network block. A size of the second feature map may be less than a size of the first feature map.

The channel conversion block 205 used in the encoder 101 may be a neural network block to output a channel-converted latent feature map for quantization by applying convolution using a predetermined number of filters to the second feature map output from the second expandable neural network block 204.

The channel conversion block 205 may convert a channel of the second feature map. That is, since a channel of the second feature map is set to correspond to a filter length (for example, in an l-th layer, a number of weight filters used to determine a weight filter of an l+1-th layer) of the second expandable neural network block, the channel conversion block 205 may convert the channel of the second feature map into a channel of an input signal.

In quantization 208, the encoder 101 may quantize the latent feature map output from the channel conversion block 205 to a value that may be represented by a predetermined bit number. In addition, the quantized latent feature map may be converted into a bitstream.

In multiplexing 209, the encoder 101 may output a total bitstream by multiplexing a quantized pitch information bitstream and a quantized latent feature map bitstream.

A neural network model including a channel conversion block 212, a first expandable neural network block 215, an upsampling block 214, a second expandable neural network block 213, and a channel conversion block 216 may be used in decoding an audio signal.

In inverse-multiplexing 210, the decoder 102 may extract a quantized pitch information bitstream and a quantized latent feature map bitstream respectively by inversely multiplexing the total bitstream received from the encoder 101.

In inverse-quantization 217, quantized pitch information may be extracted by inversely quantizing the quantized pitch information bitstream. In inverse-quantization 211, the decoder may extract a quantized latent feature map by inversely quantizing the quantized latent feature map bitstream.

The channel conversion block 212 used in the decoder 102 may be a neural network block to output a second feature map in which short-term redundancy inherent in an audio signal is restored by applying convolution using a predetermined number of filters to the quantized latent feature map that is quantized through an inverse-quantization process.

The channel conversion block 212 may convert a channel of the second feature map. Specifically, the channel conversion block 212 may convert a channel of the second feature map such that the channel of the second feature map may correspond to a filter length (for example, in an l-th layer, a number of weight filters used to determine a weight filter of an l+1-th layer) of the second expandable neural network block.

The second expandable neural network block 213 used in the decoder 102 may be a neural network block to restore the downsampled feature map by applying expandable convolution having a fixed dilation factor to the second feature map output from the channel conversion block 212.

The upsampling block 214 used in the decoder 102 may be a neural network block to restore the first feature map in which a dimension of the input feature map is expanded by applying deconvolution or subpixel convolution to the downsampled feature map output from the second expandable neural network block 213.

The first expandable neural network block 215 used in the decoder 102 may be a neural network block to output a channel-converted feature map in which long-term redundancy inherent in an audio signal is restored by applying expandable convolution having a dilation factor based on the quantized pitch information to the first feature map output from the upsampling block 214.

The channel conversion block 216 used in the decoder 102 may be a neural network block to restore an input audio signal by applying convolution that has a same number of filters to a number of channels of an original input audio signal to the channel-converted feature map output from the first expandable neural network block.

The channel conversion block 216 may convert a channel of the restored output signal. For example, since a channel of the restored output signal may correspond to a filter length (for example, in an l-th layer, a number of weight filters used to determine a weight filter of an l+1-th layer) of the first expandable neural network block, the channel conversion block 216 may convert a channel of the output signal into a mono or stereo channel to correspond to a channel of the input signal.

A model parameter such as a convolutional filter and a bias of all neural network blocks used in the encoder 101 and the decoder 102 may be trained by comparing an audio signal restored in the decoder 102 and an original audio signal input to the encoder 101. That is, to minimize a difference between the audio signal restored in the decoder 102 and the audio signal input to the encoder 101, model parameters of the channel conversion blocks 201, 205, 212, and 216, the downsampling block 203, the upsampling block 214, the first expandable neural network blocks 202 and 215, and the second expandable neural network block 204 and 213 may be updated.

For example, a receptive field of the first expandable neural network blocks 202 and 215 and the second expandable neural network blocks 204 and 213 based on a dilation factor may be determined by Equation 1 shown below.

r=Σₗ₌₁^{L}dₗ×(kₗ−1)+1 [Equation 1]

In Equation 1, r may denote a receptive field of the expandable neural network blocks 202, 204, 215, and 213 and L may denote a number of all layers included in the expandable neural network blocks 202, 204, 215, and 213. kₗ may represent a length of a convolution filter between an (I+1)-th layer and an I-th layer, in the l-th layer. kₗ may be a same value regardless of layers. dₗ may denote a dilation factor of the I-th layer. For example, dₗ may be determined by Equation 2 shown below. For example, in case a number of layers and a length of a weight filter are fixed, a receptive field of an expandable neural network block may be represented by a function of a dilation factor as in Equation 1.

dₗ=2×d_{l-1, l=2, . . . , d}_{₁}₌₁ [Equation 2]

Referring to Equation 2, a dilation factor of an I-th layer may be determined to be two times of a dilation factor of an (l−1)-th layer. However, a relationship between the dilation factor of the (l−1)-th layer and the dilation factor of the l-th layer is not limited to the described examples.

For example, a dilation factor of each layer of the first expandable neural network blocks 202 and 215 may be determined based on pitch information of an audio signal and a dilation factor of each layer of the second expandable neural network blocks 204 and 213 may be determined to be a preset fixed value regardless of an audio signal.

For example, in processes 204 and 217 of determining a dilation factor in the encoder 101 and the decoder 102, Equations 3 and 4 shown below may be used to determine a dilation factor of the first expandable neural network blocks 202 and 215 based on pitch information of an audio signal.

$$\begin{matrix}r = {\hat{t}}_{p} + 1 & [ Equation 3 ] \\ {d}_{1} = ⌊ \frac{{\hat{t}}_{p}}{( k - 1 ) \times {\sum }_{l = 1}^{L} {2}^{l - 1}} ⌋ & [ Equation 4 ]\end{matrix}$$

In Equation 3, r may denote a receptive field of the first expandable neural network blocks 202 and 215 and \hat{t}p may denote a quantized pitch lag of an audio signal. To reduce long-term redundancy, the receptive field of the first expandable neural network blocks 202 and 215 may be determined to correspond to a pitch lag of an audio signal.

In Equation 4, dₗ may represent a dilation factor of a first layer of the first expandable neural network blocks 202 and 215. k may represent a length of convolution filter between I+1-th layer and l-th layer in the l-th layer. L may denote a number of all layers included in the first expandable neural network blocks 202 and 215. └⋅┘ may represent a rounding operation. Based on a relationship defined in Equation 2, a dilation factor of the remaining layers may be obtained from the dilation factor dₗ of the first layer.

In a process of channel conversion 219, the decoder 102 may convert a channel of the restored output signal. For example, since a channel of the restored output signal may correspond to a filter length (for example, in an l-th layer, a number of weight filters used to determine a weight filter of an l+1-th layer) of the first expandable neural network block, the decoder 102 may convert a channel of the output signal into a mono or stereo channel to correspond to a channel of the input signal.

FIGS. 3A and 3B are diagrams illustrating a layer structure of a learning model according to an example embodiment.

In FIGS. 3A and 3B respectively, a filter length (in the l-th layer, a number of weight filters 304 and 314 used to determine the weight filters 304 and 314 of the l+1-th layer) of all layers 301 to 303 and 311 to 313 may be determined to be 3. FIG. 3A illustrates a layer structure showing a process of determining a weight filter 304 of an output layer in case that a receptive field 305 of a learning model is 5 and a dilation factor of the learning model is determined to be 1 in all of the layers 301 and 303.

Referring to FIG. 3A, in an input layer 301, three of the weight filters 304 may be used to determine the weight filter 304 of a hidden layer 302 and in the hidden layer 302, three of the weight filters 304 may be used to determine the weight filter 304 of the output layer 303. Referring to FIG. 3A, in the input layer 301, five of the weight filters 304 may be used to determine one weight filter 304 in the output layer 303. That is, FIG. 3A may show a case in which the receptive field 305 of the learning model is determined to be 5.

FIG. 3B illustrates a layer structure showing a process of determining a weight filter 314 of an output layer in case that a receptive field 315 of a learning model is 5 and a dilation factor of the learning model is 1 in the hidden layer and 2 in the output layer. That is, a dilation factor may increase based on a layer. For example, FIG. 3B may show an example of an expandable convolutional neural network and FIG. 3A may show an example of a typical convolutional neural network.

Referring to FIG. 3B, in an input layer 311, three of the weight filters 314 may be used to determine the weight filter 314 of a hidden layer 312 and in the hidden layer 312, three of the weight filters 314 may be used to determine the weight filter 314 of the output layer 313. Referring to FIG. 3B, in the input layer 311, seven of the weight filters 314 may be used to determine one weight filter 314 in the output layer 313. That is, FIG. 3B may show a case in which the receptive field 315 of the learning model is determined to be 7.

FIG. 4 is a diagram illustrating a layer structure of a learning model which is determined based pitch information according to an example embodiment.

FIG. 4 may show a case in which a pitch lag 405 (for example, \hat{t}p) is determined to be 3 and a filter length of all layers 401 to 403 is determined to be 2. Referring to FIG. 4, a dilation factor of the first layer 401 may be determined to be 1 based on the pitch lag. In addition, based on the dilation factor of the input layer 401, a dilation factor of a hidden layer 402 may be determined to be 2 and a dilation factor of an output layer may be determined to be 4. Accordingly, a receptive field of the learning model may be determined to be 4.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of encoding an audio signal using a learning model, the method comprising:
extracting pitch information of the audio signal;
determining a dilation factor of a receptive field of a first expandable neural network block to extract a feature map from the audio signal based on the pitch information;
generating a first feature map of the audio signal using the first expandable neural network block in which the dilation factor is determined;
determining a second feature map by inputting the first feature map into a second expandable neural network block to process the first feature map; and
converting the second feature map and the pitch information into a bitstream.

2. The method of claim 1, wherein the generating of the first feature map comprises generating the first feature map by changing a number of a channel of the audio signal and inputting the changed number of channel to the first expandable neural network block, and the determining of the second feature map further comprises changing a number of channels of the determined second feature map.

3. The method of claim 1, wherein the determining of the second feature map comprises performing downsampling on the first feature map to reduce a dimension of the first feature map and determining the second feature map by inputting the downsampled first feature map into the second expandable neural network block.

4. The method of claim 1, wherein the determining of the dilation factor comprises determining the dilation factor by approximating the receptive field of the first expandable neural network block with the pitch information.

5. The method of claim 1, wherein a dilation factor of the second expandable neural network block is predetermined to be a fixed value and a receptive field of the second expandable neural network block is determined based on the dilation factor of the second expandable neural network block.

6. The method of claim 1, further comprising:
quantizing the second feature map and the pitch information respectively,
wherein the converting into the bitstream comprises converting the quantized second feature map and the quantized pitch information into the bitstream by multiplexing.

7. A method of decoding an audio signal using a learning model, the method comprising:
extracting a second feature map of the audio signal and pitch information of the audio signal from a bitstream received from an encoder;
restoring a first feature map by inputting the second feature map into a second expandable neural network block to restore a feature map;
determining a dilation factor of a receptive field of a first expandable neural network block to restore an audio signal from a feature map based on the pitch information; and
restoring an audio signal from the first feature map using the first expandable neural network block in which the dilation factor is determined.

8. The method of claim 7, wherein the restoring of the first feature map further comprises restoring the first feature map by changing a number of channels of the second feature map and inputting the changed number of channels into the second expandable neural network block, and the restoring of the audio signal further comprises changing a number of channels of the restored audio signal to be same as a number of channels of an input signal of the encoder.

9. The method of claim 7, wherein the restoring of the audio signal comprises performing upsampling on the first feature map to expand a dimension of the first feature map and determining the audio signal by inputting the upsampled first feature map into the first expandable neural network block.

10. The method of claim 7, wherein the dilation factor is determined by approximating the receptive field of the first expandable neural network block with the pitch information in the encoder.

11. The method of claim 7, wherein a dilation factor of the second expandable neural network block is predetermined to be a fixed value and a receptive field of the second expandable neural network block is determined based on the dilation factor of the second expandable neural network block.

12. The method of claim 7, wherein the extracting of the second feature map and the pitch information of the audio signal further comprises inversely quantizing the second feature map and the pitch information respectively.

13. An encoder for performing a method of encoding an audio signal, the encoder comprising:
a processor,
wherein the processor is configured to extract pitch information of the audio signal, determine a dilation factor of a receptive field of a first expandable neural network block to extract a feature map from the audio signal based on the pitch information, generate a first feature map of the audio signal using the first expandable neural network block in which the dilation factor is determined, determine a second feature map by inputting the first feature map into a second expandable neural network block to process the first feature map, and convert the second feature map and the pitch information into a bitstream.

14. The encoder of claim 13, wherein the processor is further configured to perform downsampling on the first feature map to reduce a dimension of the first feature map and determine the second feature map by inputting the downsampled first feature map into the second expandable neural network block.

15. The encoder of claim 13, wherein the processor is further configured to determine the dilation factor by approximating the receptive field of the first expandable neural network block with the pitch information.

16. The encoder of claim 13, wherein a dilation factor of the second expandable neural network block is predetermined to be a fixed value and a receptive field of the second expandable neural network block is determined based on the dilation factor of the second expandable neural network block.
